(19) United States
(12) Patent Application Publication
(10) Pub. No.: US 2003/0208695 A1
(43) Pub. Date: Nov. 6, 2003

(54) Method and system for controlled, centrally authenticated remote access

(76) Inventors: Ronald Soto, Windsor, CO (US); Adam Michael Carr, Fort Collins, CO (US); Jon Christopher Connelly, Windsor, CO (US); Stewart Mayott, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/135,398

(22) Filed: May 1, 2002

(51) Int. Cl. H04L 9/00

(52) U.S. Cl. 713/202

(57) ABSTRACT

The present invention relates to a method and a system for remotely accessing an external node. The method of the present invention includes the following steps: requesting permission to enter a process of connecting to the external node through an internal user's node, connecting from the user's node to a central authenticating unit, verifying user information at the central authenticating unit, connecting from the central authenticating unit to the external node, and connecting from the user's node to the external node.

### BACKGROUND OF THE INVENTION

1. Field of the Invention

This invention relates generally to the field of network management, and more particularly to a method for giving maintenance and service personnel access to remote, secure networks.

2. Description of the Related Art

The conventional way to grant maintenance and service personnel access to the computers within a client's secure network is to contact the administrators of the network and have them establish one or more special accounts with names and passwords. This process can take several days. Even then, such access through a firewall may be less than satisfactory for maintenance and service purposes. In addition, security is compromised by the necessity of issuing names and passwords that can become lost or stolen. Often, the personnel must visit the client site to perform essential tests and processes.

### SUMMARY OF THE INVENTION

Briefly summarized, an embodiment of the present invention is directed to remotely accessing an external node, including the following steps: requesting permission to enter a process of connecting to the external node through an internal user's node; connecting from the user's node to a central remote access unit; verifying user information at the central remote access unit; connecting from the central remote access unit to the external node; and connecting from the user's node to the external node.

### BRIEF DESCRIPTION OF THE DRAWINGS

FIG. 1 is a block diagram illustrating system components used in a method according to an embodiment of the present invention.

FIG. 2 is a block diagram illustrating the details of the engineer desktop according to an embodiment of the present invention, as shown in FIG. 1.

FIG. 3 is a block diagram illustrating the details of the remote access server according to an embodiment of the present invention, as shown in FIG. 1.

FIG. 4 is a block diagram illustrating the details of the content server according to an embodiment of the present invention, as shown in FIG. 1.

FIG. 5 is a block diagram illustrating the details of the SPOP node according to an embodiment of the present invention, as shown in FIG. 1.

FIG. 6 is a flow chart illustrating method steps according to an embodiment of the present invention.

FIG. 7 is a continuation of the flowchart of FIG. 6 according to an embodiment of the present invention.

FIG. 8 is a continuation of the flowchart of FIG. 7 according to an embodiment of the present invention.

FIG. 9 is a continuation of the flowchart of FIG. 8 according to an embodiment of the present invention.

FIG. 10 is a continuation of the flowchart of FIG. 9 according to an embodiment of the present invention.

FIG. 11 is a continuation of the flowchart of FIG. 10 according to an embodiment of the present invention.

### DETAILED DESCRIPTION OF THE PREFERRED EMBODIMENTS

The present invention provides a method for granting system maintenance and service personnel located at an engineering site access to a customer's computer network for service and maintenance purposes.

To facilitate understanding of the present invention, the following definitions are provided:

### Definitions:

SPOP: Support Point Of Presence server or node. A server installed within the customer's intranet, behind the customer's firewall, which can access other computers at the customer site for service and maintenance purposes, and which can be accessed by service engineers in a secure manner. It is thus an external node.

Content Server: A server in which a RADIUS server has been implemented. It is also a portal for submitting data or getting content data to and from an SPOP.

Engineer's Desktop: a personal computer or workstation that is programmed to function as an internal user's node, and which a service and maintenance engineer can use to access, monitor, and service a remote, secure network with the assistance of an external SPOP note.

Enterprise: An array of one or more computers networked together to serve the data processing and communication needs of an organization that uses computers.

IKE: Internet Key Exchange. Peer-to-peer authentication and agreed-to security association that defines how systems are to exchange and protect data.

Intranet: a private network that is contained within an enterprise. It may comprise one or many interlinked Local Area Networks (LANs) or Wide Area Networks (WANs). Typically, an intranet includes connections through a firewall to the outside Internet.

IPSEC: Internet Protocol Security for the L2TP protocol. A packet-level security system that secures individual IP, or Internet protocol, packets themselves, and that is used by L2TP.

L2TP: Layer Two Tunneling protocol. L2TP is a protocol that in part enables the operation of a VPN, or virtual private network, over the Internet between two nodes.

Node: A connection point, either a redistribution point or an endpoint for data transmissions. In general, a node may be one or more computers programmed or engineered to recognize and to process transmissions or to forward them to other nodes.

RADIUS: Remote Authentication Dial-In User Service or Server is a security authentication client/server protocol widely used by Internet service providers on other remote access servers. RADIUS is the most common means of authenticating and authorizing both dial-up and also tunneled network users. One of possibly several customer verification and access servers located in a buffer zone outside the firewall of the engineer's intranet where account creation and validation occurs. RADIUS is only used for authentication into the customer's intranet. It is not used for logging into and communicating with computers at the engineering site (“engineer's intranet”). Thus, it is a remote authenticating service.

Remote Access Server (RAS): One of possibly several servers located at a maintenance and service engineering site (the “engineer's intranet”) where maintenance and service personnel work. The RAS and its associated software are set up to service requests from maintenance and service engineers seeking access to remote networks for maintenance and service purposes. It thus functions as a central remote access unit.

Security Association: Describes how the systems will exchange and protect data.

VPN: Virtual Private Network. It causes the insecure public Internet network to behave as if it were a secure private network. It is a private data network that makes use of the public telecommunications infrastructure, maintaining privacy through the use of a tunneling protocol and security procedures. Using a VPN in part involves encrypting data before sending it through the public network and decrypting it at the receiving end. A VPN also authenticates end points and authenticates packets against tampering. Thus, a virtual tunnel or passage may be established between two nodes on separated networks.

### Overview of the Hardware and Software Portions of an Embodiment of the Invention

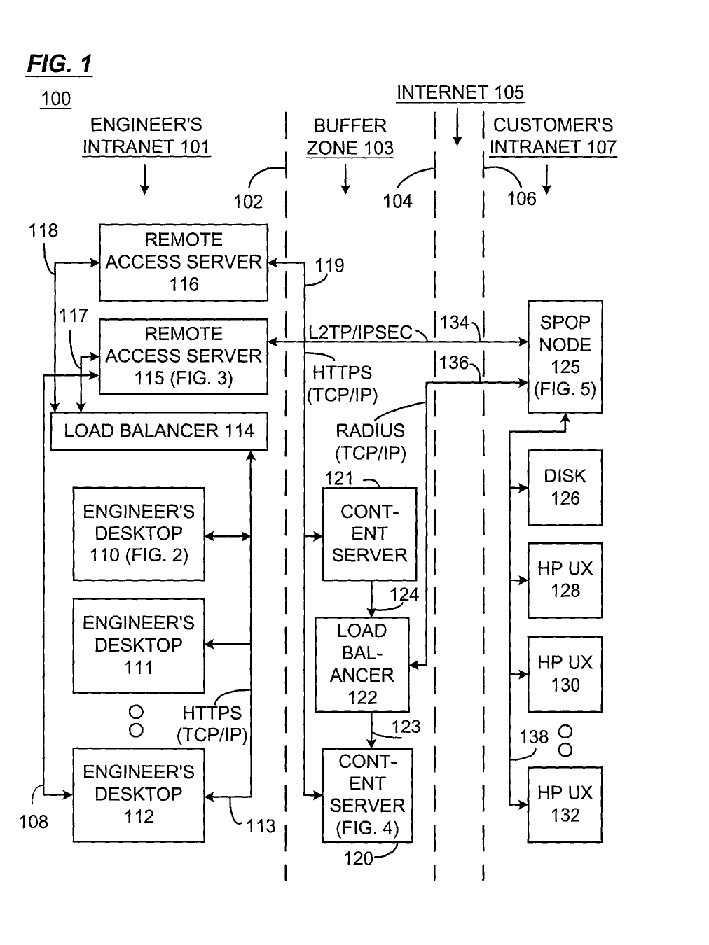

FIG. 1 is a block diagram illustrating a system 100 for enabling service and maintenance engineers to access a customer's computers, illustrating the components that cooperate according to an embodiment of the present invention.

The system of FIG. 1 allows a user to log in to his desktop and obtain a graphical display of the SPOP node that the user requests access to. There is no burden on the user, nor is there any burden on the system to generate passages for each user to each SPOP node through different methods according to the user and according to the client side terminals. Instead, the system of FIG. 1 allows the user to connect to the SPOP node through a centrally located verification and authentication unit. Not only is this system efficient, it makes the connection easy for both sides of the connection.

The system 100 is divided into four main sections: An engineer's intranet 101; a buffer zone 103; the Internet 105; and a customer's intranet 107. In between each of the four main sections are firewalls 102, 104, and 106. A firewall is a set of related hardware and/or software, located on one or more nodes bridging two zones, that protects the resources of a private network from users of other networks. The term also implies the security policy that is implemented by these nodes. An enterprise with an intranet that allows its users to access the wider Internet installs a firewall to prevent outsiders from accessing its own private data resources without authorization and to control what outside resources users of the enterprise may access. Basically, a firewall examines each message and determines whether to forward it toward its destination, reroute it, or block it. A firewall is often installed in a specially designated computer separate from the rest of the network so that no incoming messages can get directly at private network resources.

Between the engineer's intranet 101 and the buffer zone 103, there is the internal firewall 102. Between the buffer zone 103 and the Internet 105, there is the external firewall 104. Between the Internet 105 and the customer's intranet 107, there is the customer firewall 106.

Within the engineer's intranet 101, there is at least one remote access server, and in the illustrative system 100 there are two remote access servers 115 and 116. These are connected to a load balancer 114 which routes remote access requests over the paths 117 or 118 to one or the other of the servers 115 and 116, thereby balancing out the load on the one or more servers. There might be additional remote access servers in a given maintenance and service enterprise, depending upon the volume of use. Also, within the intranet 101 there are a plurality of engineer's desktops such as the three desktops 110, 111 and 112, for example. These are workstations or personal computers assigned to individual maintenance and service engineers, and they are typically used for many purposes. The engineer's desktops 110, 111 and 112 are connected 113 by the engineer's intranet 101 to the load balancer 114. When a connection to a customer site is requested and initiated by an engineer using an engineer's desktop 110, the request is routed by the load balancer 114 to one of the two remote access servers 115 or 116. A terminal services connection such as 108 is then established between an engineer's desktop 110 and a selected remote access server 115.

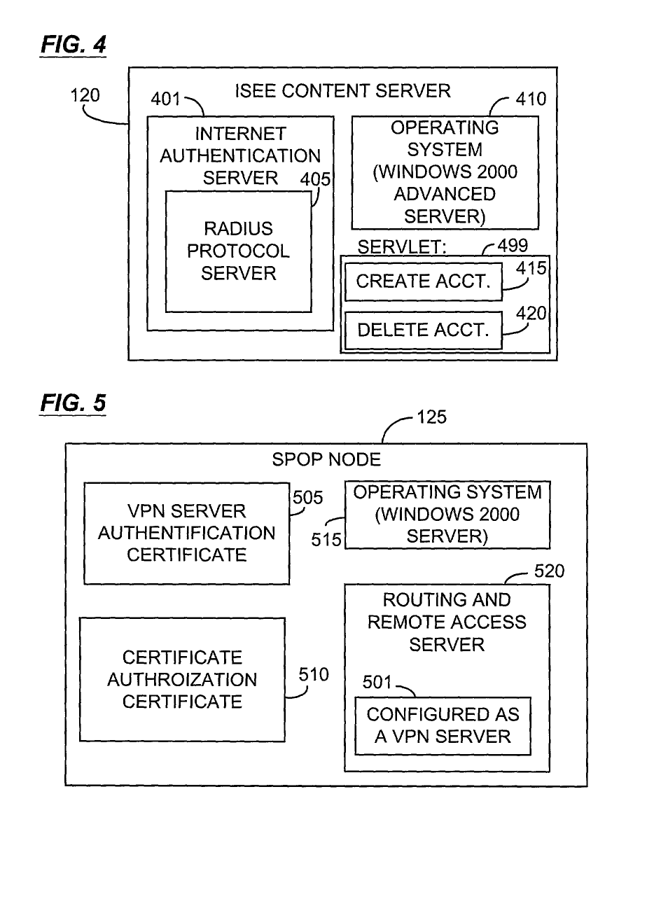

The buffer zone 103 is outside the engineer's intranet 101 where it can be accessed directly by messages coming from remote sites, such as the customer's intranet 107, over the Internet 105. Within this buffer zone 103, there are one or more content servers, in this case two content severs 120 and 121, connected by paths 123 and 124 to a load balancer 122 that equalizes the load on these two servers wherein a RADIUS server 405 (FIG. 4) functions as a verification and access controller. The RADIUS server is, in essence, a service enabled on the content servers. The remote access servers 115 and 116 located within the engineer's intranet 101 are connected to the content servers 120 and 121 via a secure path or connection 119 through the firewall 102. The load balancer 122 connects the two content servers 120 or 121 directly to the Internet 105. For example, in this particular embodiment of the invention, one or more SPOP nodes 125 may be located within different customer's intranets such as the intranet 107, and these SPOP nodes may connect to a content server 120 or 121 via the load balancer 122 and deposit onto the content server 120 or 121 data gathered from the computers 128, etc., within the customer's intranet 107. Arrangements (not shown) are made whereby engineers may examine this data from their engineer's desktops 110, 111, and 112.

The Internet 105 serves as a connection 136 between the load balancer 122 and one or more SPOP nodes, such as the illustrative SPOP node 125 within the customer enterprise defined by the customer's intranet 107.

The SPOP node 125 is connected, at 138, by the intranet 107 to a plurality of disk storage units such as the illustrative disk 126 and to a plurality of servers and workstations such as the three illustrative HP Unix nodes 128, 130 and 132, for example. The SPOP node 125 is thus able to access, operate, test, and otherwise examine the computers, workstations, servers, and other equipment attached to the customer's enterprise as defined by the customer's intranet 107. Other equipment that the SPOP node can be arranged to test and to service might be routers, DHCP servers, tape drives, communication channels, printers, scanners, and other types of enterprise-related equipment. A maintenance or service engineer present at the customer site and having access to the SPOP node 125 can thus perform all manner of network service and maintenance tasks. However, as is explained below, this embodiment of the invention enables a maintenance or service engineer to perform such network service and maintenance tasks from one of the engineer's desktops 110, 111, or 112 without having to travel to the customer site.

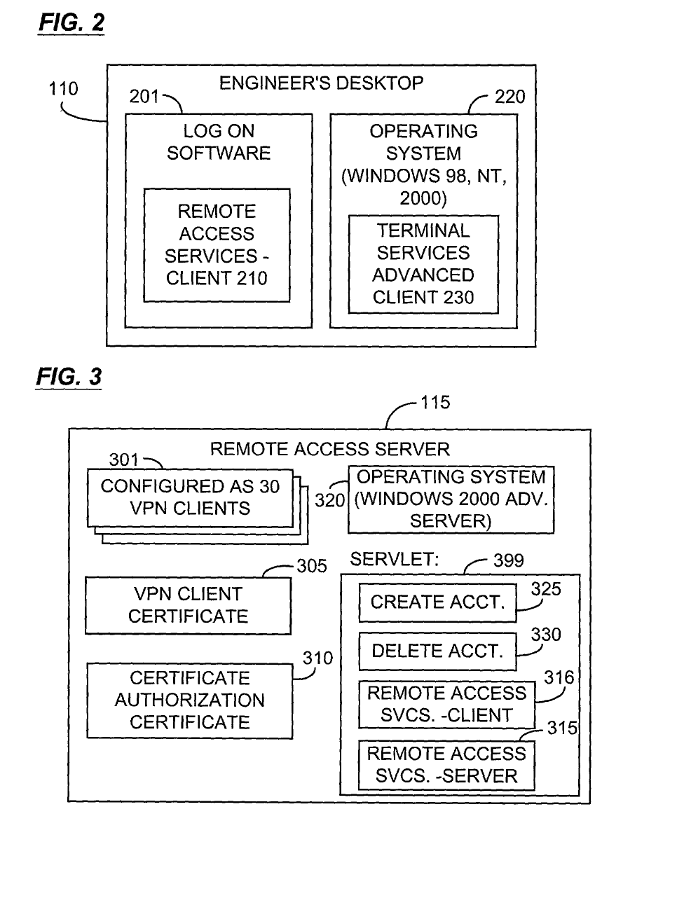

FIG. 2 presents details of a typical engineer's desktop 110. Within the engineer's desktop 110, there is log-in software 201 that enables an engineer to do service and maintenance work relating to particular SPOP nodes, such as the node 125, located within a given customer's intranet 107. An example of a software that may be used is called Insight, and it operates under the Windows 98, Windows NT, or Windows 2000 operating system 220. The log-in software 201 first provides an engineer with the ability to access data previously returned by remote SPOP nodes, as was explained briefly above, without the need to establish any direct connection to a remote SPOP node.

To implement an embodiment of the present invention, the log-in software 201 is provided with the ability to enable an engineer to logon to a remote SPOP node, such as the node 125, and then to remotely access and service client computers and other devices, in accordance with the system and method of the present invention. Within the log-in software 201 there is a remote access services client 210 which enables an engineer to request VPN connections to the SPOP. Also included in the engineer's desktop is Terminal Services Advanced Client (TSAC) 230. TSAC allows the engineer to view the virtual screen of a remote computer, such as the SPOP node 125, and to manipulate that remote computer just as if the engineer were present at the client site and using the SPOP node 125 computer directly.

FIG. 3 presents the details of a typical remote access server 115. The remote access server 115 runs on an operating system 320 such as Windows 2000 Advanced Server. The server 115 also contains a multi-function servlet 399. One servlet function 325 creates temporary accounts, and another servlet function 330 deletes such temporary accounts (see listing in Appendix A). This servlet 399 can communicate over the path 119 with the content servers 120 and 121 to create and later to delete temporary accounts whereby an SPOP located at a customer site, such as the SPOP node 125, may be provided with an account to access the remote access servers 115 and 116 with the permission of the radius server 405 installed on the contents servers 120 or 121. The servlet 399 can be a JAVA program. The remote access server 115 is also configured as thirty separate VPN (virtual private network) clients 301. It contains a single VPN client certificate 305 that is shared by the thirty VPN clients 301. It also contains a certificate authorization certificate 310. Finally, the multi-function servlet 399 also contains both a remote access services server 315 and also a remote access services client 316 which work together, as will be explained, to provide a bridge between the remote access client 210 within the engineer's desktop 110 and a remote access server 520 within the SPOP node 125 such that the engineer may control the node 125 and also view its virtual screen.

FIG. 4 presents the details of a typical content server 120 with the RADIUS protocol server 405 embedded into the content server 120. The content server 120 has an operating system 410 such as Windows 2000 Advanced Server. The content server 120 includes an Internet authentication server 401, and within that, a RADIUS protocol server program 405 which implements management of customer accounts and checking and authorization of customer access to the RADIUS servers and to other servers.

The typical content server 120 also has a dual purpose servlet 499 that creates an account 415 and deletes an account 420 which is shown in Appendix B. This servlet 499 operates under the control of the servlet 399 in FIG. 3. Accordingly, the remote access server 115 may command the content server 120 or 121 to create and later to delete temporary engineer access accounts that are used in this embodiment of the invention. Like the servlet 399 of FIG. 3, this servlet 399 also can be a JAVA program.

FIG. 5 presents the details of the typical SPOP node 125. The SPOP node 125 is, in this case, a PC class computer that contains an operating system 515 such as a Windows 2000 Server. It is configured as a VPN (virtual private network) server 501 and contains a VPN server authentication certificate 505 and a certificate authorization certificate 510. It contains a routing and remote access services server 520 that implements the VPN server 501, which, in its turn, permits a client computer, such as the engineer's desktop 110, to control the SPOP node 125 and permits an engineer at the desktop 110 to view, on the screen of the desktop 110, whatever would be displayed on the physical screen of the node 125 (assuming the node 125 did have a physical screen which was set to display this particular task running on the node 125).

### The Steps of an Embodiment of the Invention

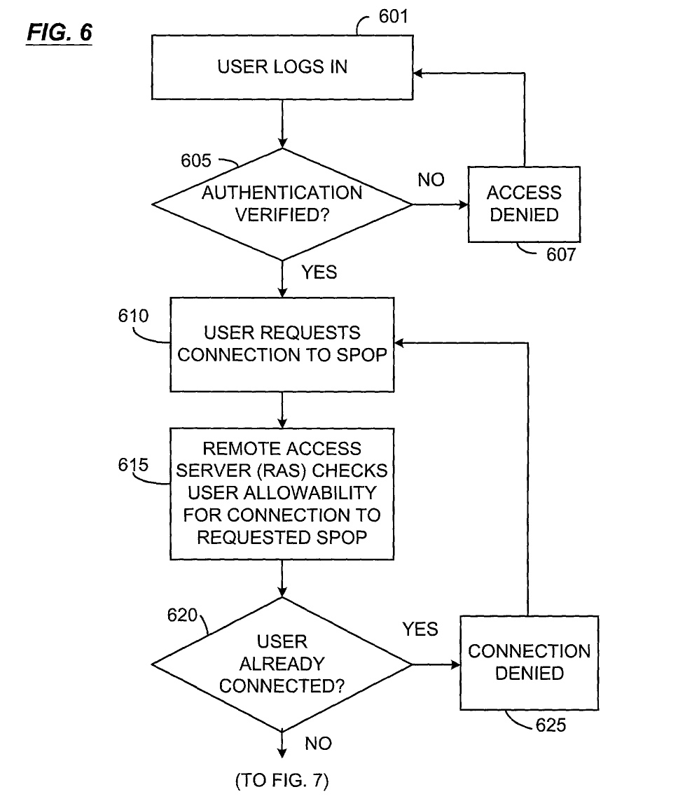

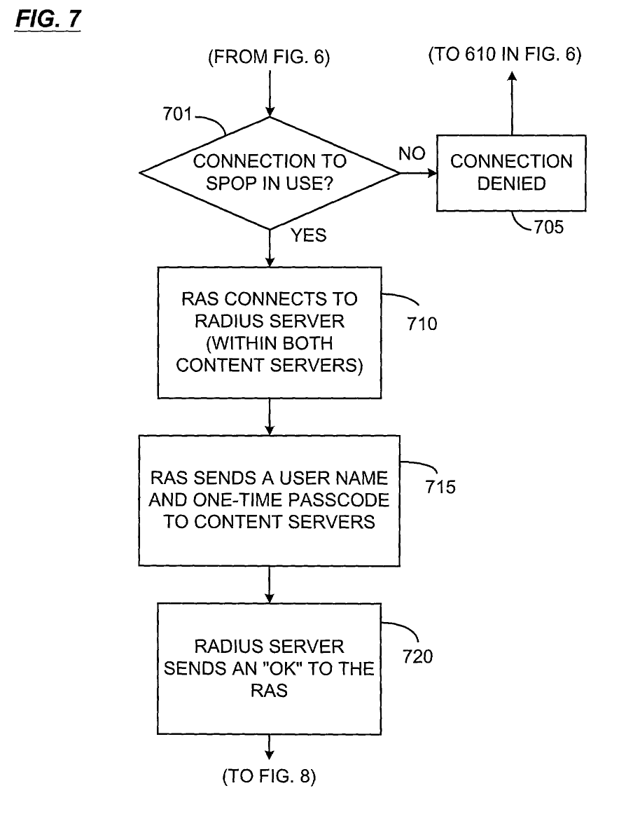

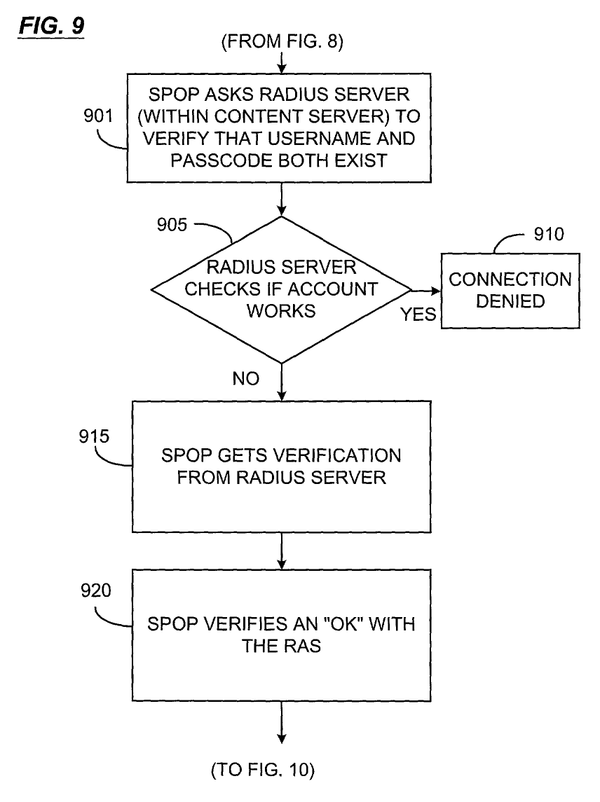

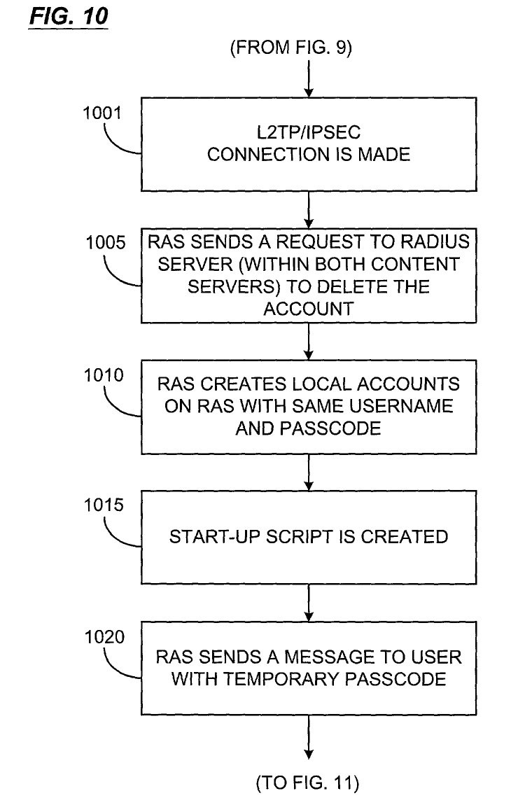

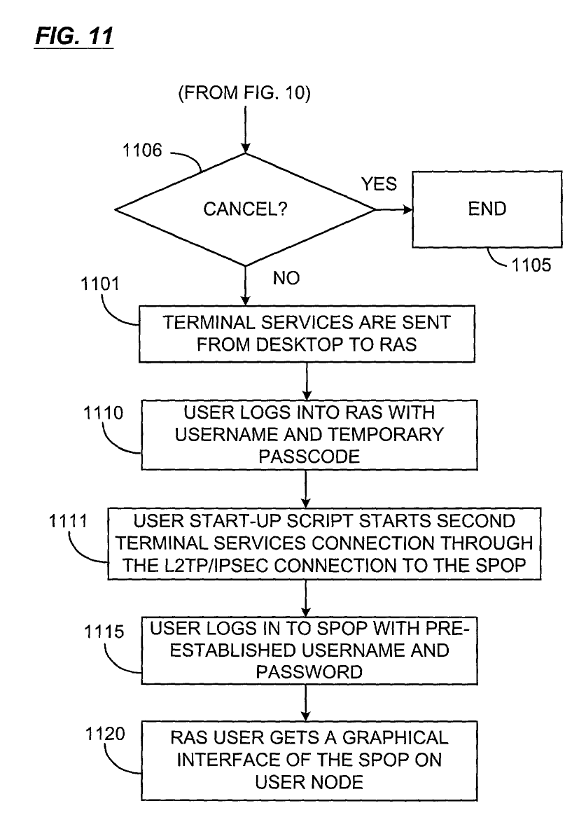

FIGS. 6-11 are flow diagrams illustrating steps according to an embodiment of the present invention. For purposes of illustration, it will be assumed that a maintenance or service engineer, sitting at the workstation 110 (FIGS. 1 and 2), wishes to log on to the SPOP node 125 within the intranet 107 of a particular customer's enterprise to check on the operation of one of the servers 128, 130, 132 that are running a version of Unix. An example would be to run a version of Hewlett Packard's version of Unix. The log-in software 201 is assumed to be running on the workstation 110, for example, in one embodiment of the present invention.

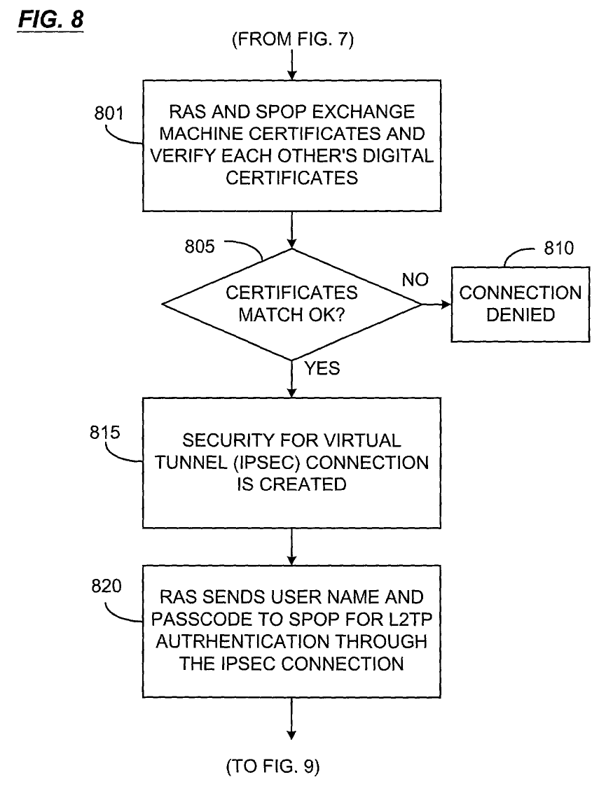

With reference to FIG. 6, in step 601, the engineer begins by logging on to Insight 201 with a login name and password. In step 605, the log-in software 201 determines whether to grant the engineer access to use this software to potentially connect to any SPOP node. If access is denied, step 607, then the engineer is taken back to step 601 and may re-enter a user name and password. If access is granted, then the engineer proceeds to step 610 where the engineer requests a connection to the SPOP node 125, by the HTTPS secure TCP/IP communication protocol to the remote access server 115. In step 620, if the engineer who is requesting a connection is already connected to any SPOP, then the connection request is denied (step 625), and the engineer is taken back to the step 610. If the engineer is not already connected to any SPOP, the system 100 then proceeds to step 701 (FIG. 7).

At step 701, the system 100 checks if the SPOP node 125 with which a connection has been requested is already in use. If so, then the connection is denied at step 705, and the engineer is taken back to step 610. If the connection is free, then in step 710, the remote access server 115 connects to the content servers 120 and 121.

At step 715, the remote access server 115 creates a username and one-time passcode and sends them to the RADIUS protocol servers 405 within the content server 120 and 121. This one-time password is randomly generated. The content servers 120 and 121 create the user account and send a positive verification to the random access server 115, in step 720.

At step 801, the remote access server 115 and the SPOP node 125 exchange machine certificates and verify each other's digital certificates. A digital certificate is an electronic “credit card” that establishes credentials when attempting any type of business or other transactions over the Internet. The digital certificate may include the user's name, a serial number, expiration dates, and a digital signature. The digital signature is of the certificate-issuing authority so that the digital signature can be verified to insure that the certificate is genuine. This is to insure that the connection being made is to and from the correct machine terminals.

At step 805, the remote access server 115 and the SPOP node 125 check if the digital certificates match. If there is not a match, then in step 810, the connection is denied. If there is a match, then at step 815, security for a virtual tunnel between the remote access server 115 and the SPOP node 125 is built. The security for the virtual tunnel can be an IPSEC connection, for example. In step 820, the remote access server 115 sends the username and the one-time password that it created to the SPOP node 125 via the IPSec connection.

The SPOP node 125, in step 901, sends a verification request to the content server 120 asking the content server 120 to verify that the username and one-time password sent to it by the remote access server 115 actually does exist. In step 905, the content server 120 follow up on the verification request to verify whether or not the username and the one-time password sent to it by the remote access server 115 works. If the account does not work, then in step 910, the connection is denied. If the account does work, then in step 915, the SPOP node 125 gets a positive verification. At step 920, the SPOP node 125 verifies that the verification is positive with the remote access server 115.

In step 1001, a virtual tunnel 134 is created between the remote access server 115 and the SPOP node 125. The virtual tunnel 134 can be an L2TP/IPSEC, for example. At step 1005, the remote access server 115 sends a request to the content servers 120 to delete the temporary account that was created. At step 1010, the remote access server 115 creates a local account on the remote access server 115 using the same username and one-time password as the one that had been deleted from the content server 120. A start-up script is created and placed in the defined user's startup directory in step 1015. At step 1020, the remote access server 115 uses the previously generated one-time password and provides it to the “user”.

At step 1106, the human user is given the option to cancel the operation. If the user selects YES, then in step 1105, the connection is ended. If the user selects NO, then the user is taken to step 1101.

At step 1101, insight fires off the terminal services advanced client 230 on the engineer's desktop 110 directing it to log into the remote access server 115 that was used to create the VPN secure tunnel 134 to the SPOP node 125. The user logs into the remote access server using their username and the one-time password (step 1110), that was presented to him or her in step 1020.

Next, at step 1111, the start-up script initiates a second terminal services connection through the secure tunnel 134 to the SPOP node 125. The user is now presented with a login dialog to the SPOP node 125. The user logs in with the predefined username and passcode at step 1115. At step 1120, the remote access user is presented with a graphical interface of the SPOP node 125 on his or her user's node, in this case the engineer's desktop 110.

Accordingly, the engineer, sitting at the engineer's workstation 110, now views on his or her display a virtual screen image of a display image originating on the SPOP node 125 and conveyed first from the SPOP node 125 to the server 115 over the network path 134 and, in particular, to the remote access server 115; and then conveyed from remote access server 115 to the engineer's workstation's client 210, which displays the virtual screen image to the engineer.

Other embodiments of the present invention are apparent to those skilled in the art from a consideration of the specification and the practice of the invention disclosed therein. It is intended that the specification be considered as exemplary only with the true scope and spirit of the invention being indicated by the claims following Appendices A and B.

[image]

[image]

[image]

[image]

[image]

[image]

[image]

[image]

[image]

[image]

What is claimed is:

1. A method for remotely accessing an external node, the method comprising the steps of:
(a) requesting permission to enter a process of connecting to the external node through an internal user's node;
(b) connecting from the user's node to a central remote access unit;
(c) verifying user information at the central remote access unit;
(d) connecting from the central remote access unit to the external node; and
(e) connecting from the user's node to the external node.

2. The method according to claim 1, wherein the external node is a node in a customer's enterprise.

3. The method according to claim 1, wherein the central remote access unit comprises a remote access server.

4. The method according to claim 1, wherein the central remote access unit comprises a remote authenticating service.

5. The method according to claim 1, wherein a connection between the user's node and the external node is via a virtual passage.

6. The method according to claim 1, wherein a connection between the remote access unit and the external node is via a L2TP/IPSec or other equivalent secure connection.

7. The method according to claim 1, wherein the permission to attempt to connect is granted when the user inputs valid user information into a software program installed on the internal user's node.

8. The method according to claim 1, wherein after step (a), a remote access server checks user allowability for connection to the external node.

9. The method according to claim 1, wherein a remote access server creates a temporary account.

10. The method according to claim 1, wherein after step (d), security for the connection between a remote access server and the external node is built.

11. The method according to claim 1, wherein in step (e), the user's node is connected to the central remote access unit which is connected to the external node.

12. A method for remotely accessing an external node, the method comprising the steps of:
(a) requesting permission to enter a process of connecting to the external node through an internal user's node;
(b) connecting from the user's node to a remote access server;
(c) connecting from the remote access server to a customer verification and access server;
(d) transmitting temporary account information to the customer verification and access server;
(e) connecting from the remote access server to the external node;
(f) building security for a virtual tunnel between the remote access server and the external node;
(g) transmitting the temporary account information to the external node;
(h) verifying, at the customer verification and access server, if connection is legitimate;
(i) verifying, at the remote access server, if the connection is legitimate;
(j) building the virtual tunnel between the remote access server and the external node;
(k) deleting the temporary account information on the customer verification and access server;
(l) transmitting permission for connection, from the external node to the remote access server;
(m) creating a startup script for the user;
(n) displaying connection instructions on the user's node; and
(o) connecting the user's node to the external node, via the remote access server.

13. The method according to claim 12, wherein the external node is a node in a customer's enterprise.

14. The method according to claim 12, wherein the virtual tunnel is a L2TP IPSec or other equivalent secure connection.

15. The method according to claim 12, wherein in step (a), the user inputs user information onto a software program installed on the internal user's node.

16. The method according to claim 12, wherein the remote access server creates the temporary accounts.

17. A system for remotely accessing an external node, the system comprising of:
(a) an internal user's node;
(b) a remote access server;
(c) a customer verification and access server;
(d) a connector to connect the internal user's node to the remote access server;
(e) a second connector to connect the remote access server to the customer verification and access server;
(f) a third connector to connect the remote access server to the external node;
(g) a verifier to verify that the connections between the remote access server and the customer verification and access server and between the remote access server and the external node are legitimate; and
(h) a virtual tunnel between the remote access server and the external node, wherein a user can remotely access the external node via the internal user's node.

18. The system of claim 17, wherein the external node is a node in a customer's enterprise.

19. The system of claim 17, wherein the virtual tunnel is a L2TP IPSec or other equivalent secure connection.

20. An apparatus for remotely accessing an external node, the apparatus comprising:
(a) means for requesting permission to enter a process of connecting to the external node through an internal user's node;
(b) means for connecting from the user's node to a remote access server;
(c) means for creating a temporary account on the remote access server;
(d) means for connecting from the remote access server to a customer verification and access server, wherein customer verification and access is a remote authentication service;
(e) means for transmitting the temporary account information to the customer verification and access server;
(f) means for connecting from the remote access server to the external node;
(g) means for transmitting the temporary account information to the external node;
(h) means for building security for a virtual tunnel between the remote access server and the external node;
(i) means for verifying, at the customer verification and access server, if connection is legitimate;
(j) means for verifying, at the remote access server, if the connection is legitimate;
(k) means for building the virtual tunnel between the remote access server and the external node;
(l) means for deleting the temporary account information on the customer verification and access server;
(m) means for transmitting permission for connection from the external node to the remote access server;
(n) means for displaying connection instructions on the user's node; and
(o) means for connecting the user's node to the external node, via the remote access server.
